(19) United States
(12) Patent Application Publication
(10) Pub. No.: US 2013/0347067 A1
(43) Pub. Date: Dec. 26, 2013

(54) DYNAMIC HUMAN INTERACTIVE PROOF

(71) Applicants: Weisheng Li, Bothell, WA (US); Prabu Raju, Issaquah, WA (US); Manu Manianchira, Redmond, WA (US); Cristian Salvan, Redmond, WA (US); Kris Iverson, Redmond, WA (US)

(72) Inventors: Weisheng Li, Bothell, WA (US); Prabu Raju, Issaquah, WA (US); Manu Manianchira, Redmond, WA (US); Cristian Salvan, Redmond, WA (US); Kris Iverson, Redmond, WA (US)

(73) Assignee: Microsoft Corporation, Redmond, WA (US)

(21) Appl. No.: 13/528,875

(22) Filed: Jun. 21, 2012

(51) Int. Cl. G06F 21/20

(52) U.S. Cl. 726/3

(57) ABSTRACT

In one embodiment, a human interactive proof portal 140 may control access to an online data service 122. A communication interface 280 may establish a human interactive proof session 600 with a client user 110 by presenting a proof challenge set having multiple proof challenges. A clock 290 may record a challenge response time for each proof challenge. A processor 220 may provide access to an online data service 122 based on the human interactive proof session.

### BACKGROUND

A data service may provide services for free on the internet. A malicious entity may take advantage of these services using a “bot”, a software application that may run automated tasks on the internet. The hot may overtax the server for the data service, hijack the data service for nefarious use, or interrupt normal use of the data service. For example, the bot may set up fake free e-mail accounts to send out spam, purchase event tickets for “scalping”, or may strip mine a public database.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to controlling access to an online data service. A communication interface may establish a human interactive proof session with a client user by presenting a proof challenge set having multiple proof challenges. A clock may record a challenge response time for each proof challenge. A processor may provide access to an online data service based on the human interactive proof session.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a data network.

FIG. 2 illustrates, in a block diagram, one embodiment of a computing device.

FIGS. 3a-b illustrate, in block diagrams, alternate embodiments of proof challenges.

FIG. 4 illustrates, in a block diagram, one embodiment of a location record.

FIG. 5 illustrates, in a block diagram, one embodiment of a user record.

FIG. 6 illustrates, in a flow diagram, one embodiment of a human interactive proof session.

FIG. 7 illustrates, in a flowchart, one embodiment of a method for controlling access to an online data service.

FIG. 8 illustrates, in a flowchart, one embodiment of a method for executing a human interactive proof session.

### DETAILED DESCRIPTION

Embodiments are discussed in detail below. While specific implementations are discussed, these implementations are for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a human interactive proof portal.

An online data service may use a human interactive proof (HIP) system, also called a completely automated public Turing test to tell computers and humans apart (CAPTCHA) system, to prevent automated actors from using or abusing a free online data service. A human interactive proof system has a user perform a task that an automated system would not be able to easily perform. A human interactive proof system may use a human interactive proof portal to provide the user with a proof challenge, such as an image or a distorted text word. To solve the proof challenge, the client user may have to identify an object in the image or read the distorted text word. With complex proof challenges, the human interactive proof system may distinguish more accurately between a human and a software application, while conversely providing a more unpleasant experience for the client user. Once the client user solves the proof challenge, the human interactive proof portal may grant the client user access to the online data service.

Malicious agents have found many ways to circumvent the human interactive proof system. Optical character recognition (OCR) has advanced to the point that given enough time many of the proof challenges may be solved automatically. Additionally, the malicious agents may forward the proof challenge to shops of human users dedicated to just solving the proof challenges, referred to as “human sweatshops”.

However, these circumventions tend to be time consuming. Therefore, a human interactive proof system may identify time delays that signify optical character recognition applications and human sweatshops. Further, the human interactive proof portal may iteratively provide a proof challenge set having multiple proof challenges during a human interactive proof session, even as the client user correctly solves the proof challenges. A proof challenge set size describes the number of proof challenges presented to the user. As multiple proof challenges are used, the proof challenges may be both shorter and more complex. The proof challenge may have one or two challenge characters for the client user to identify. The challenge characters may be overlaid with a high non-Gaussian noise background, providing a pattern with a non-normal distribution to obscure the challenge characters. The high non-Gaussian noise background may make the challenge character hard to read by an optical character recognition application.

The human interactive proof portal may record a challenge response time for each challenge response. The challenge response time measures the elapsed time from when the proof challenge is sent to when a challenge response is received. The human interactive proof portal may use the challenge response time to identify client users that are using optical character recognition applications and human sweatshops.

The human interactive proof portal may use an adjustable reference response time to determine if the challenge response time is acceptable. The reference response time may be an acceptable upper bound response time, or a model response time with an available range above and below the reference response time.

The proof challenge set size may be increased or reduced based on the user success history or the user timing history. The user success history describes how often the client user correctly identifies the challenge characters. The user success history may give partial credits for near misses, such as identifying a “P” as an “R”. The user timing history describes the challenge response time for each challenge response. The user timing history may describe an average challenge response time, or record each average challenge response time. The reference response time may be adjusted based on the user success history or the user timing history.

The human interactive proof portal may use the internet protocol address and a geo-location database to identify the location of the client user. The human interactive proof portal may use the geo-location information to determine the reference response time and the challenge proof set size.

Thus, in one embodiment, a human interactive proof portal may control access to an online data service. A communication interface may establish a human interactive proof session with a client user by presenting a proof challenge set having multiple proof challenges. A clock may record a challenge response time for each proof challenge. A processor may provide access to an online data service based on the human interactive proof session.

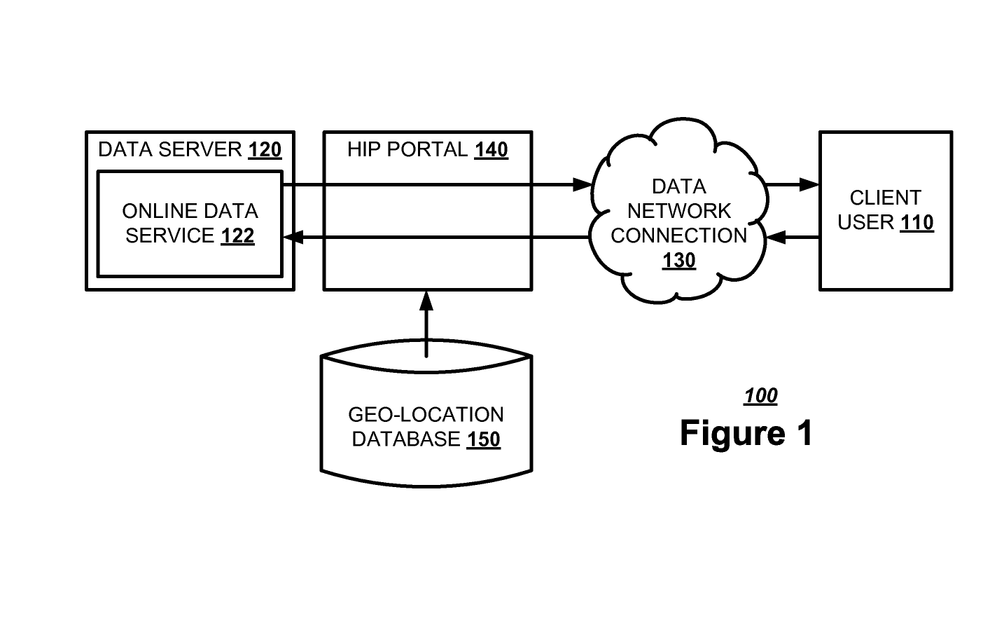

FIG. 1 illustrates, in a block diagram, one embodiment of a data network 100. A client user 110 may connect to a data server 120 via a data network connection 130, such as the internet. The client user 110 may access an online data service 122 executed by the data server 120. The online data service 122 may protect access to the service using a human interactive proof portal 140. The human interactive proof portal 140 may be executed by the data server 120 or by a separate server. The human interactive proof portal 140 may connect to a geo-location database 150 that associates an internet protocol address to an actual geo-location. The human interactive proof portal 140 may use a geo-location database 150 to identify a geo-location for the client user 110 by using the internet protocol address originating the access request to identify the actual geo-location.

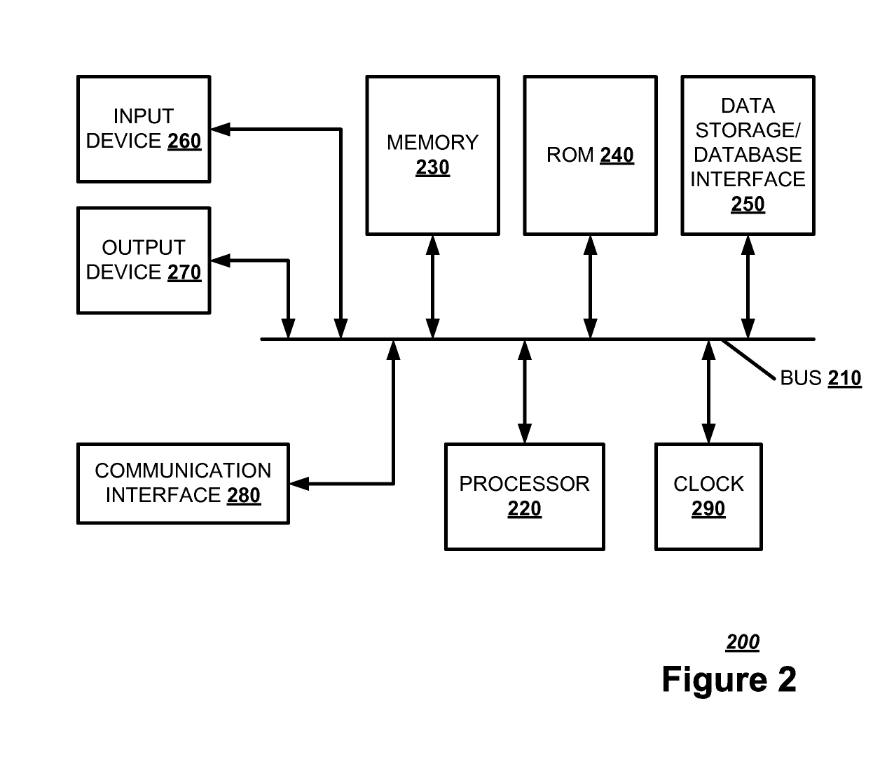

FIG. 2 illustrates a block diagram of an exemplary computing device 200) which may act as a client user device 110, a data server 120, or a human interactive portal 140. The computing device 200 may combine one or more of hardware, software, firmware, and system-on-a-chip technology to implement a client user 110, a data server 120, or a human interactive portal 140. The computing device 200 may include a bus 210, a processor 220, a memory 230, a read only memory (ROM) 240, a data storage 250, an input device 260, an output device 270, a communication interface 280, or a clock 290. The bus 210 may permit communication among the components of the computing device 200.

The processor 220 may include at least one conventional processor or microprocessor that interprets and executes a set of instructions. The memory 230 may be a random access memory (RAM) or another type of dynamic storage device that stores information and instructions for execution by the processor 220. The memory 230 may also store temporary variables or other intermediate information used during execution of instructions by the processor 220. The ROM 240 may include a conventional ROM device or another type of static storage device that stores static information and instructions for the processor 220. The data storage 250 may include any type of tangible machine-readable medium, such as, for example, magnetic or optical recording media, such as a digital video disk, and its corresponding drive. A tangible machine-readable medium is a physical medium storing machine-readable code or instructions, as opposed to a transitory medium or signal. The data storage 250 may store a set of instructions detailing a method that when executed by one or more processors cause the one or more processors to perform the method. The data storage 250 may also be a database or a database interface with the geo-location traffic database 150.

The input device 260 may include one or more conventional mechanisms that permit a user to input information to the computing device 200, such as a keyboard, a mouse, a voice recognition device, a microphone, a headset, a gesture recognition device, a touch screen, etc. The output device 270 may include one or more conventional mechanisms that output information to the user, including a display, a printer, one or more speakers, a headset, or a medium, such as a memory, or a magnetic or optical disk and a corresponding disk drive. The communication interface 280 may include any transceiver-like mechanism that enables computing device 200 to communicate with other devices or networks. The communication interface 280 may include a network interface or a transceiver interface. The communication interface 280 may be a wireless, wired, or optical interface. The clock 290 may provide timing information for various functions performed by a client user device 110 or a human interactive portal 140.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 250, or from a separate device via the communication interface 280.

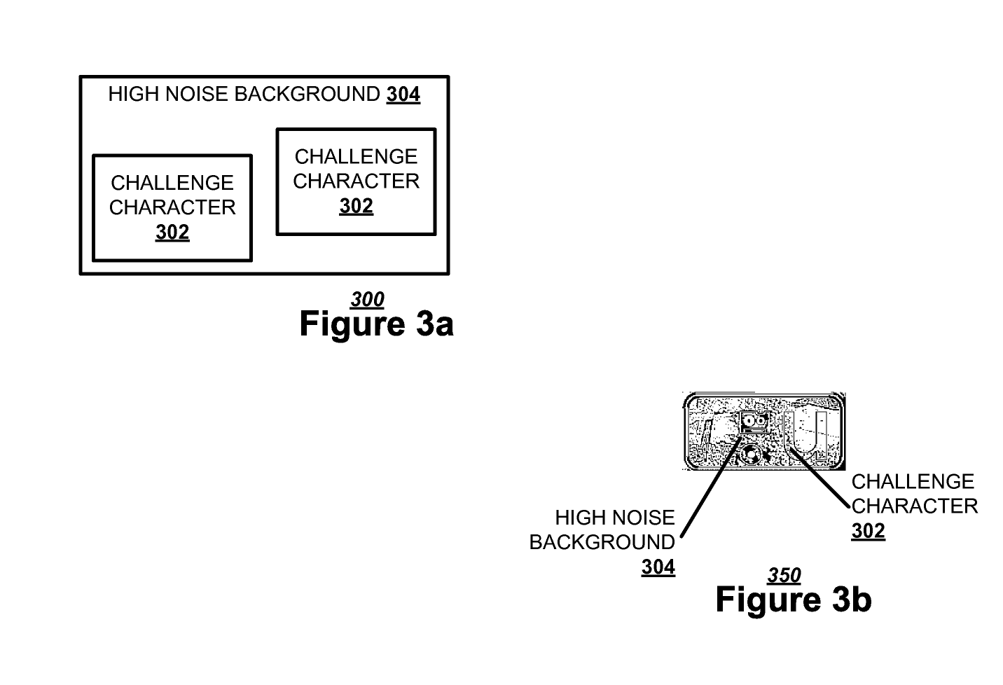

The human interactive proof portal 140 may establish a human interactive proof session with the client user 110 to determine whether to grant access to the online data service 122. The human interactive proof portal 140 may send a proof challenge set having multiple proof challenges for the client user 110 to solve. FIG. 3a illustrates, in a block diagram, one embodiment of a generic proof challenge 300. The generic proof challenge 300 may have one or more challenge characters 302 obscured by a high non-Gaussian noise background 304. A challenge character 302 is a letter, number, or symbol that a client user 110 may identify to solve the proof challenge 300. A high non-Gaussian noise background 304 is a random pattern with a non-normal distribution that obscures the challenge character 302 so that a computer may not use optical character recognition to identify the challenge character 302.

The proof challenge 300 may be designed to be immediately recognizable by a human user, creating enough of a time differential to distinguish between a real human user and a bot or a human sweatshop. As multiple proof challenges are used, each proof challenge 300 may use fewer challenge characters 302. In addition to fewer challenge characters 302 improving the user experience of the proof challenge 300, the proof challenge may be solved quickly by a human user. The high non-Gaussian noise background 304 may prevent optical character recognition from solving proof challenge 300, causing any malicious actor wanting to solve the proof challenge 300 to send the proof challenge to a human sweatshop. The transmission time to the human sweatshop may increase the solving time, alerting the human interactive proof portal 140) to the involvement of the human sweatshop.

For example, the proof challenge may have one to two challenge characters 302. FIG. 3b illustrates a specific example of a proof challenge 350. The challenge character “u” 302 may be obscured by a high non-Gaussian noise background 304 of scales, a cassette, and a compact disc.

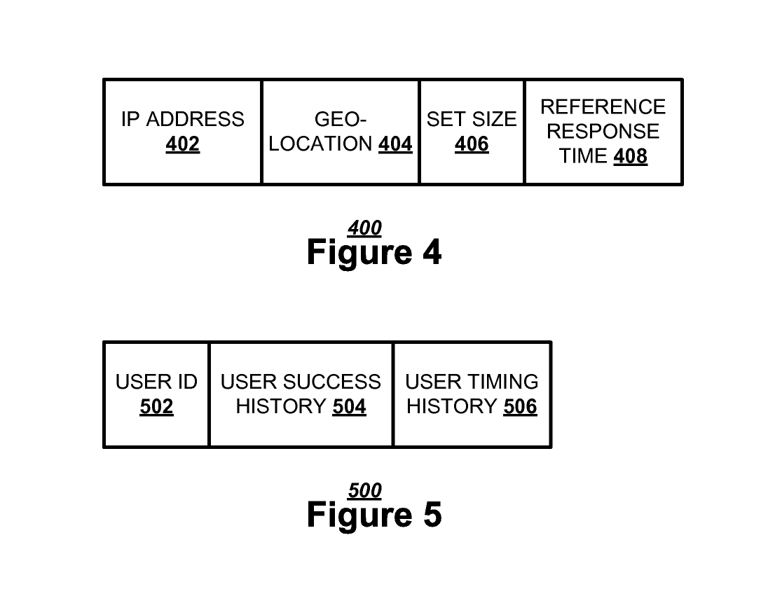

The geo-location database 150 may store a location record to indicate optimum use parameters at each geo-location. FIG. 4 illustrates, in a block diagram, one embodiment of a location record 400. A geo-location traffic database 150 may store location record 400 associating an internet protocol address 402 with a geo-location 404. The location record 400 may identify an initial proof challenge set size 406 based on the reputation for access requests from that geo-location 404. For example, a geo-location with a reputation for hosting malicious actors may have a larger proof challenge set size 406. The location record 400 may identify an initial reference response time 408 based on the network speed associated with that geo-location 404.

The human interactive proof portal 140) may maintain a user record of the client user 110. FIG. 5 illustrates, in a block diagram, one embodiment of a user record 500. The human interactive proof portal 140 may identify the user record 500 with a client user identifier (ID) 502. The client user identifier 502 may be associated with an internet protocol address of the user or with a cookie stored in the internet browser of the user. The user record 500 may store a user success history 504 tracking the number of proof challenges 300 that the client user 110 has solved. The user success history 504 may include partial solves. A partial solve is a response by the client user 110 that identifies a challenge character 302 similar to the actual challenge character 302 of the proof challenge 300. For example, a client user 110 may identify a proof challenge 300 having challenge character “3” 302 as having a challenge character “B” 302. The user record 500 may store the user timing history 506 tracking a challenge response time for the human interactive proof session. The user timing history 506 may store an average response time for the proof challenges 300 or an array of each response time for each proof challenge 310.

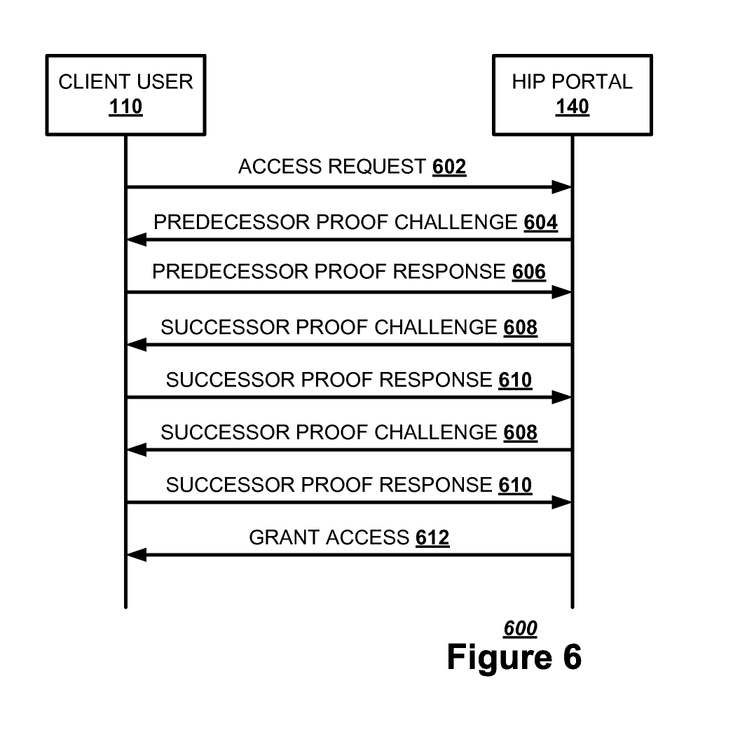

FIG. 6 illustrates, in a flow diagram, one embodiment of a human interactive proof session 600. The client user 110 may send an access request 602 to the human interactive proof portal 140. The human interactive proof portal 140 may return a predecessor proof challenge 604 to the client user 110. The client user 110 may provide a predecessor proof response 606 to the human interactive proof portal 140 to solve the predecessor proof challenge 604. The human interactive proof portal 140 may then return a successor proof challenge 608 to the client user 110. The client user 110 may provide a successor proof response 610 to the human interactive proof portal 140 to solve the successor proof challenges 608. The human interactive proof portal 140 may then return further successor proof challenges 608 to the client user 110. The client user 110 may provide further successor proof responses 610 to the human interactive proof portal 140 to solve the successor proof challenges 608. If the client user 110 solves a sufficient number of proof challenges in the proof challenge set, the human interactive proof portal 140 may grant access 612 to the client user 110.

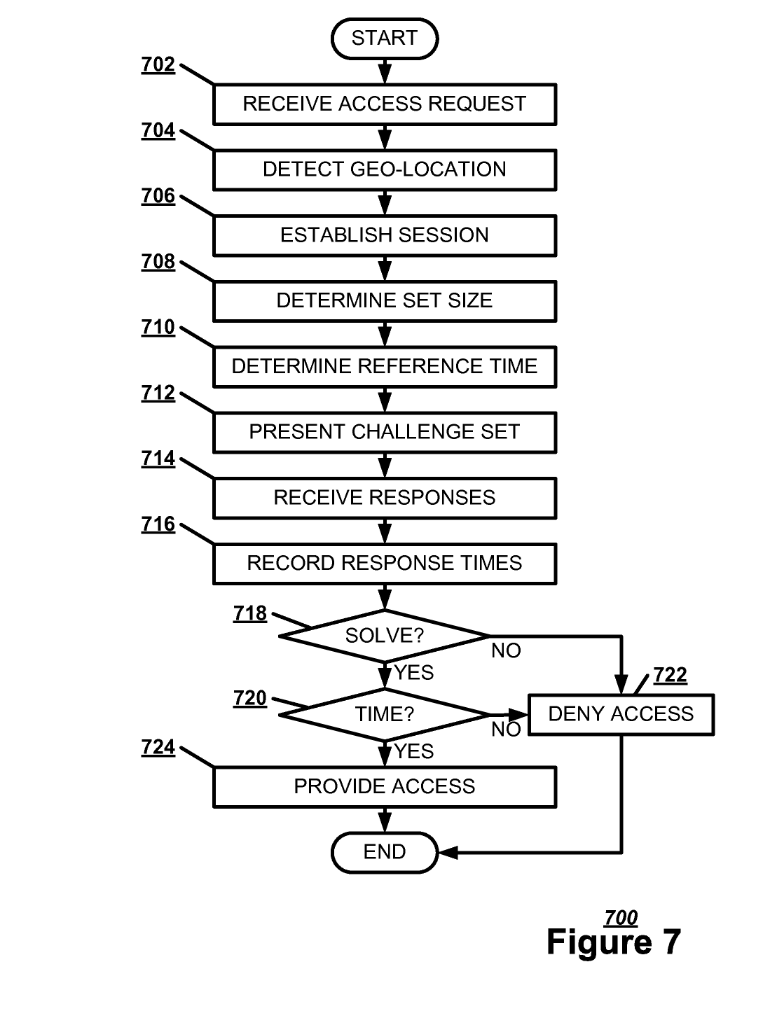

FIG. 7 illustrates, in a flowchart, one embodiment of a method 700 for controlling access to an online data service. The human interactive proof portal 140 may receive an access request 602 from a client user 110 (Block 702). The human interactive proof portal 140 may detect a user geo-location for the client user by checking an internet protocol address 402 against a geo-location database 150 (Block 704). The human interactive proof portal 140 may establish a human interactive proof session 600 with the client user 110 accessing an online data service 122 (Block 706). The human interactive proof portal 140) may determine a proof challenge set size 406 based on the user geo-location (Block 708). The human interactive proof portal 144) may determine a reference response time 408 based on user geo-location (Block 710). The human interactive proof portal 140 may iteratively present a proof challenge set having multiple proof challenges to the client user 110 (Block 712). The human interactive proof portal 140 may present a proof challenge having one to two challenge characters 302 and a high non-Gaussian noise background 304 obscuring the challenge characters 302. The human interactive proof portal 140 may receive a proof response to each proof challenge in the proof challenge set from the client user 110 (Block 714). The human interactive proof portal 140 may record a challenge response time for each proof challenge of the proof challenge set of the human interactive proof session (Block 716). If the client user 110 fails to solve the proof challenge set (Block 718) or the client user 110 fails to solve the proof challenge set in an acceptable average response time (Block 720), the human interactive proof portal 140 may deny access to the online data server 122 (Block 722). Otherwise, the human interactive proof portal 140 may provide access to the online data service 122 based in part on the human interactive proof session and the challenge response time (Block 724).

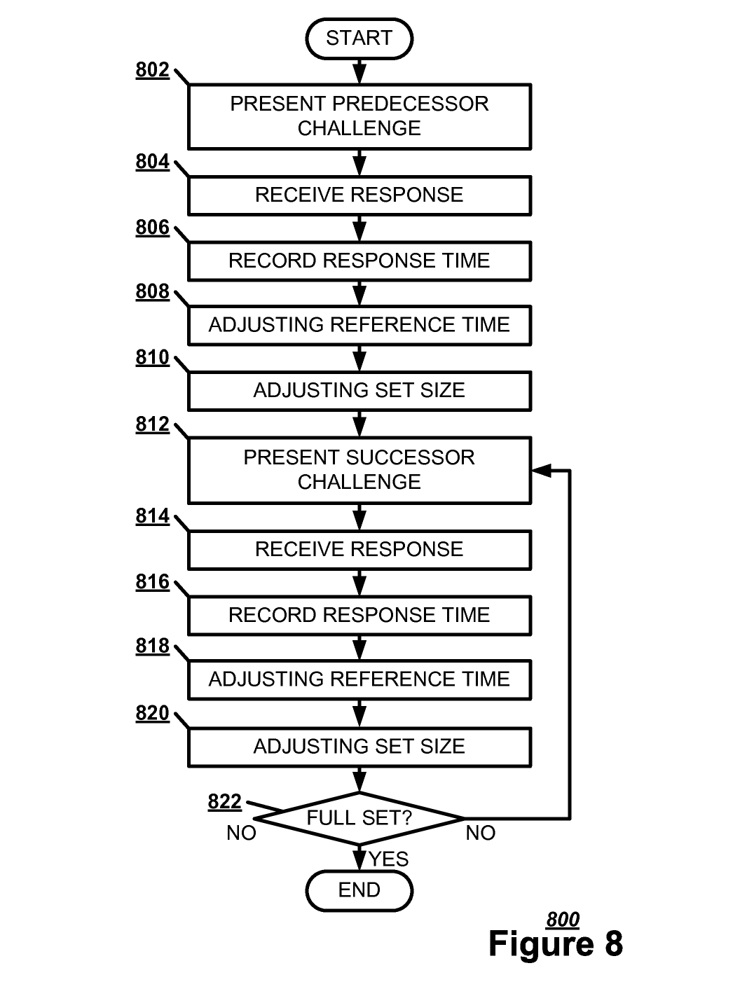

FIG. 8 illustrates, in a flowchart, one embodiment of a method 800 for executing an iterative human interactive proof session 600. The human interactive proof portal 140 may present a predecessor proof challenge 604 of a proof challenge set to the client user 110 as part of the human interactive proof session (Block 802). A predecessor proof challenge 604 is a proof challenge that precedes a successor proof challenge. The human interactive proof portal 140 may present a predecessor proof challenge 604 having one to two challenge characters 302 and a high non-Gaussian noise background 304 obscuring the challenge characters 302. The human interactive proof portal 140) may receive a predecessor proof response 606 from the client user 110 (Block 804). The human interactive proof portal 140 may record a predecessor challenge response time to the predecessor proof challenge 604 (Block 806). The human interactive proof portal 140 may adjust the reference response time 408 based on the predecessor challenge response time (Block 808). The human interactive proof portal 140 may adjust the proof challenge set size 406 based on the predecessor challenge response time (Block 810).

The human interactive proof portal 140 may present a successor proof challenge 608 of a proof challenge set to the client user 110 upon successful completion of the predecessor proof challenge (Block 812). A successor proof challenge 608 is a proof challenge that follows a successor proof challenge. The human interactive proof portal 140 may present a successor proof challenge 608 having one to two challenge characters 302 and a high non-Gaussian noise background 304 obscuring the challenge characters 302. The human interactive proof portal 140 may receive a successor proof response 610 from the client user 110 (Block 814). The human interactive proof portal 140 may record a successor challenge response time to the successor proof challenge 608 (Block 816). The human interactive proof portal 140 may adjust the reference response time 408 based on the successor challenge response time and a user timing history 506 (Block 818). The human interactive proof portal 140 may adjust the proof challenge set size 406 based on the successor challenge response time and a user success history 504 (Block 820). If each challenge proof in the challenge proof set has not been shown (Block 822), the human interactive proof portal 140 may present a successor proof challenge 608 of a proof challenge set to the client user 110 as part of the human interactive proof session (Block 812).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include non-transitory computer-readable storage media for carrying or having computer-executable instructions or data structures stored thereon. Such non-transitory computer-readable storage media may be any available media that can be accessed by a general purpose or special purpose computer. By way of example, and not limitation, such non-transitory computer-readable storage media can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above are also included within the scope of the non-transitory computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, such details are not meant to limit the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents define the invention, rather than any specific examples given.

We claim:

1. A machine-implemented method, comprising:
establishing a human interactive proof session with a client user accessing an online data service;
presenting a predecessor proof challenge of a proof challenge set to the client user as part of the human interactive proof session;
presenting a successor proof challenge of the proof challenge set to the client user upon successful completion of the predecessor proof challenge; and
providing access to the online data service based on the human interactive proof session.

2. The method of claim 1, further comprising:
recording a predecessor challenge response time to the predecessor proof challenge.

3. The method of claim 1, further comprising:
adjusting a proof challenge set size based on a predecessor challenge response time.

4. The method of claim 1, further comprising:
recording a successor challenge response time to the successor proof challenge; and
adjusting a proof challenge set size based on the successor challenge response time.

5. The method of claim 1, further comprising:
detecting a user geo-location for the client user.

6. The method of claim 1, further comprising:
adjusting a proof challenge set size based on a user success history.

7. The method of claim 1, further comprising:
presenting the predecessor proof challenge having from one to two challenge characters.

8. The method of claim 1, further comprising:
presenting the predecessor proof challenge having a high non-Gaussian noise background obscuring a challenge character.

9. A tangible machine-readable medium having a set of instructions detailing a method stored thereon that when executed by one or more processors cause the one or more processors to perform the method, the method comprising:
establishing a human interactive proof session with a client user accessing an online data service;
recording a challenge response time to a proof challenge of the human interactive proof session; and
providing access to the online data service based in part on the challenge response time.

10. The tangible machine-readable medium of claim 9, wherein the method further comprises:
presenting iteratively a proof challenge set having multiple proof challenges to the client user.

11. The tangible machine-readable medium of claim 9, wherein the method further comprises:
adjusting a proof challenge set size based on the challenge response time.

12. The tangible machine-readable medium of claim 9, wherein the method further comprises:
detecting a user geo-location for the client user.

13. The tangible machine-readable medium of claim 9, wherein the method further comprises:
determining a reference response time based on a user geo-location.

14. The tangible machine-readable medium of claim 9, wherein the method further comprises:
adjusting a reference response time based on a user timing history.

15. The tangible machine-readable medium of claim 9, wherein the method further comprises:
presenting the proof challenge having from one to two challenge characters.

16. The tangible machine-readable medium of claim 9, wherein the method further comprises:
presenting the proof challenge having a high non-Gaussian noise background obscuring a challenge character.

17. A human interactive proof portal, comprising:
a communication interface that establishes a human interactive proof session with a client user by presenting a proof challenge set having multiple proof challenges;
a clock that records a challenge response time for each proof challenge; and
a processor that provides access to an online data service based on the human interactive proof session.

18. The human interactive proof portal of claim 17, further comprising:
a database interface that connects to a geo-location database that associates an internet protocol address with a geo-location to allow the processor to detect a user geo-location.

19. The human interactive proof portal of claim 18, wherein the processor sets a reference response time based on the user geo-location.

20. The human interactive proof portal of claim 17, wherein the processor adjusts a reference response time based on a user timing history.
